(19) United States
(12) Patent Application Publication
(10) Pub. No.: US 2022/0332118 A1
(43) Pub. Date: Oct. 20, 2022

(54) WASTE LIQUID COLLECTION UNIT AND LIQUID DISCHARGE APPARATUS

(71) Applicant: Nobuyuki AKAISHI, Kanagawa (JP)

(72) Inventor: Nobuyuki AKAISHI, Kanagawa (JP)

(73) Assignee: Ricoh Company, Ltd., Tokyo (JP)

(21) Appl. No.: 17/719,693

(22) Filed: Apr. 13, 2022

(30) Foreign Application Priority Data
Apr. 15, 2021 (JP) 2021-069339

(51) Int. Cl. B41J 2/165

(52) U.S. Cl. CPC B41J 2/16523

(57) ABSTRACT

A waste liquid collection unit is located over a print medium in a discharge direction of a liquid discharge head. The collection unit includes an absorber; a tray housing the absorber exposed to a nozzle surface of the head; and a pressing member to press the absorber toward a bottom surface of the tray. The pressing member includes a base material extending in an alignment direction of nozzles and end members connected to ends of the base material and displaceable to be biased to an inner wall surface of the tray in an axial direction when the pressing member is placed in the tray. The end members include a first fitting portion in a surface facing the inner wall surface. The tray includes a second fitting portion in the inner wall surface. The first and second fitting portions are fitted when the pressing member is placed in the tray.

### CROSS-REFERENCE TO RELATED APPLICATIONS

This patent application is based on and claims priority pursuant to 35 U.S.C. § 119(a) to Japanese Patent Application No. 2021-069339, filed on Apr. 15, 2021, in the Japan Patent Office, the entire disclosure of which is incorporated by reference herein.

### BACKGROUND

### Technical Field

Embodiments of the present disclosure relate to a waste liquid collection unit and a liquid discharge apparatus.

### Related Art

In an ink jet continuous print machine, in order to prevent ink drying in a nozzle of a discharge head during printing, dried ink is periodically discharged to the surface of an unnecessary region between pages of continuous sheet or rolled sheet which is a print medium (hereinafter, also referred to as flushing). The ink jet continuous print machine is configured such that a head array is arranged in a direction orthogonal to the conveyance direction of the print medium for the reason of one-pass printing, and the width of the head array corresponds to the maximum width of the print medium such as a rolled sheet. Therefore, when the paper width of the print medium to be printed is narrow, the ink droplets to be discharged between the pages by flushing are not discharged onto the paper in an area where there is no paper surface at a position facing the discharge head, and thus a tray for landing the ink droplets by flushing is arranged on the lower side of the print medium to be conveyed.

In general, there is a technique by which an absorbent sponge is arranged in the flushing tray to absorb and hold the ink so that the ink is collected in the tray as waste ink. The conventional method of collecting ink with an absorber on a flushing tray has a problem that the ink is easily deposited on the upper surface of the absorber. Therefore, in order to prevent the deposition, a melamine sponge having high permeability may be provided as the absorber, and the absorber may be divided for the purpose of improving the exchangeability of the absorber.

However, the melamine sponge is lightweight, and the weight of one divided piece of the sponge would become significantly light. In addition, the melamine sponge is made of a material likely to be electrically charged. Therefore, there is a disadvantage that the sponge is easily floated due to the airflow in the machine caused by the conveyance of the print medium and the electrical charging of the print medium. In order to solve such a disadvantage, there is a technique by which a pressing member physically pressing the sponge from above is arranged to suppress floating of the divided pieces of the sponge.

### SUMMARY

According to an embodiment of the present disclosure, there is provided a waste liquid collection unit to be located over a print medium in a discharge direction in which a liquid discharge head discharges liquid. The waste liquid collection unit includes an absorber, a tray, and a pressing member. The absorber absorbs the liquid discharged from the liquid discharge head. The tray houses the absorber such that the absorber is exposed to a nozzle surface of the liquid discharge head. The pressing member presses the absorber toward a bottom surface of the tray. The pressing member includes a base material and end members. The base material extends in an alignment direction of nozzles of the liquid discharge head. The end members are connected to ends of the base material and displaceable in such a manner that the end members are biased to an inner wall surface of the tray in an axial direction of the base material when the pressing member is placed in the tray. The end members include a first fitting portion in a surface facing the inner wall surface. The tray includes a second fitting portion in the inner wall surface. The first fitting portion and the second fitting portion are fitted to each other when the pressing member is placed in the tray.

According to another embodiment of the present disclosure, there is provided a liquid discharge apparatus that includes the liquid discharge head and the waste liquid collection unit.

### BRIEF DESCRIPTIONS OF THE DRAWINGS

The aforementioned and other aspects, features, and advantages of the present disclosure would be better understood by reference to the following detailed description when considered in connection with the accompanying drawings, wherein:

FIG. 1 is a diagram illustrating an example of a general configuration of a liquid discharge apparatus according to an embodiment of the present disclosure;

FIG. 2 is a diagram illustrating an example of configurations of a liquid discharge unit and a cap unit of the liquid discharge apparatus, according to an embodiment of the present disclosure;

FIG. 3 is a plan view of a liquid discharge head of the liquid discharge apparatus, according to an embodiment of the present disclosure;

FIG. 4 is a diagram illustrating a positional relationship between the liquid discharge head and a liquid receiving unit in the liquid discharge apparatus, according to an embodiment of the present disclosure;

FIG. 5 is a diagram illustrating a configuration of a liquid receiving unit according to a comparative example;

FIG. 6 is a diagram illustrating an example of a configuration of the liquid receiving unit according to an embodiment of the present disclosure;

FIG. 7A is a plan view of the liquid receiving unit of FIG. 6;

FIG. 7B is an enlarged view of the liquid receiving unit of FIG. 7A; and

FIG. 8 is a diagram illustrating an example of a positional relationship between the liquid receiving unit of FIG. 6 and a sheet.

The accompanying drawings are intended to depict embodiments of the present disclosure and should not be interpreted to limit the scope thereof. The accompanying drawings are not to be considered as drawn to scale unless explicitly noted.

### DETAILED DESCRIPTION OF EMBODIMENTS

Hereinafter, a waste liquid collection unit and a liquid discharge apparatus according to embodiments of the present disclosure will be described in detail with reference to the drawings. In addition, the scope of the present disclosure is not limited by the following embodiments, and constituent elements in the following embodiments include constituent elements that can be easily conceived by those skilled in the art, constituent elements that are substantially identical, and constituent elements in an equivalent range. Various omissions, substitutions, changes, and combinations of constituent elements can be made without departing from the gist of the following embodiments.

In an embodiment of the present disclosure, a rolled continuous sheet (hereinafter, also referred to as sheet) will be described as an example of print medium, but the print medium that can be used in a liquid discharge apparatus is not limited to the continuous sheet. For example, the print medium may be a cut sheet or the like. The continuous sheet here refers to a continuous sheet or a continuous form in which stitch perforations for cutting are formed at predetermined intervals. Pages in the continuous sheet are, for example, areas sandwiched by stitch perforations at predetermined intervals. Sheets used in the liquid discharge apparatus include plain paper, high-quality paper, thin paper, thick paper, recording paper, overhead projector (OHP) sheet, synthetic resin film, metal thin film, and other sheets to which liquid can adhere.

General configuration of liquid discharge apparatus

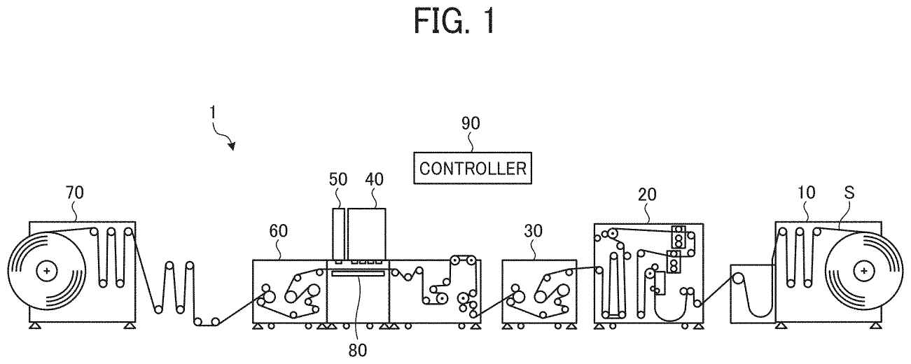

FIG. 1 is a diagram illustrating an example of a general configuration of a liquid discharge apparatus according to an embodiment of the present disclosure. The general configuration of the liquid discharge apparatus according to the present embodiment will be described with reference to FIG. 1.

A liquid discharge apparatus 1 illustrated in FIG. 1 is an apparatus that performs image formation, that is, printing, by discharging ink (an example of liquid) onto a sheet S that is a loaded print medium. As illustrated in FIG. 1, the liquid discharge apparatus 1 includes a loading unit 10, a pre-processing unit 20, a drying unit 30, a liquid discharge unit 40, a post-processing unit 50, a drying unit 60, an unloading unit 70, a liquid receiving unit 80, and a controller 90.

The loading unit 10 is a unit that loads the sheet S, which is a print medium. The loading unit 10 conveys the loaded sheet S to the pre-processing unit 20.

The pre-processing unit 20 is a unit that performs pre-processing on the sheet S loaded in by the loading unit 10. The pre-processing unit 20 conveys the pre-processed sheet S to the drying unit 30.

The drying unit 30 is a unit that dries the sheet S pre-processed by the pre-processing unit 20. The drying unit 30 conveys the dried sheet S to the liquid discharge unit 40.

The liquid discharge unit 40 discharges ink from a liquid discharge head to form an image on the sheet S. The sheet S on which an image has been formed by the liquid discharge unit 40 is conveyed to the post-processing unit 50.

The post-processing unit 50 is a unit that performs post-processing on the sheet S on which an image has been formed by the liquid discharge unit 40. The sheet S having undergone the post-processing by the post-processing unit 50 is conveyed to the drying unit 60.

The drying unit 60 is a unit that dries the sheet S having undergone the post-processing by the post-processing unit 50. The drying unit 60 conveys the dried sheet S to the unloading unit 70.

The unloading unit 70 is a unit that winds up and unloads the sheet S dried by the drying unit 60.

The liquid receiving unit 80 is a waste liquid collection unit that is arranged below the sheet S conveyed under the liquid discharge head of the liquid discharge unit 40 and receives the ink discharged from the liquid discharge head. That is, the sheet S is conveyed between the liquid discharge unit 40 and the liquid receiving unit 80, and the liquid receiving unit 80 is arranged over the sheet S in the ink discharge direction of the liquid discharge unit 40. Specifically, the liquid receiving unit 80 receives the ink by absorbing the ink discharged from the liquid discharge head with the absorber.

The controller 90 is a device that controls the operations of units described above in the liquid discharge apparatus 1.

As described above, the liquid discharge apparatus 1 includes the loading unit 10, the pre-processing unit 20, the drying unit 30, the liquid discharge unit 40, the post-processing unit 50, the drying unit 60, and the unloading unit 70, but the configurations of the units may be different depending on the type of the sheet S. For example, the pre-processing unit 20 may not be included according to the type of the sheet S.

Configuration of Liquid Discharge Unit

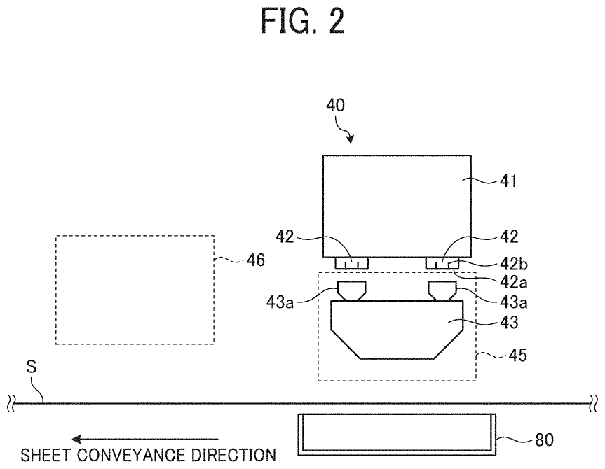

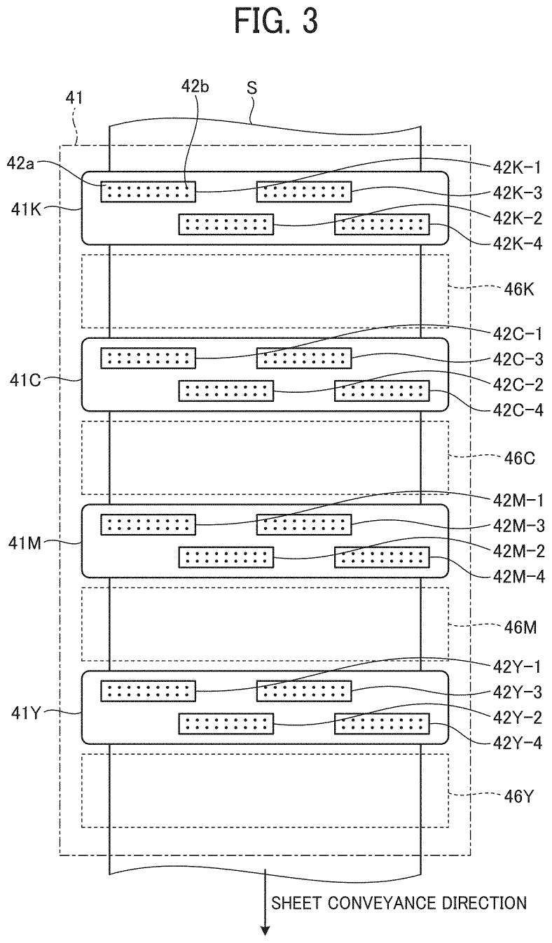

FIG. 2 is a diagram illustrating an example of configurations of a liquid discharge unit and a cap unit of the liquid discharge apparatus according to the present embodiment. FIG. 3 is a plan view of a liquid discharge head of the liquid discharge apparatus according to the present embodiment. A configuration of the liquid discharge unit 40 in the liquid discharge apparatus 1 according to the present embodiment will be described with reference to FIGS. 2 and 3.

As illustrated in FIG. 2, the liquid discharge unit 40 includes a liquid discharge head 41 and a cap unit 43. As will be described later with reference to FIG. 3, four sets of the liquid discharge head 41 and the cap unit 43 are provided in correspondence with C (cyan), M (magenta), Y (yellow), and K (black). For the sake of simple description, FIG. 2 illustrates the liquid discharge head 41 and the cap unit 43 corresponding to a certain color.

The liquid discharge head 41 is a unit that discharges ink from a plurality of head units 42 onto the sheet S conveyed in the sheet conveyance direction illustrated in FIG. 2 to form an image. Specifically, the ink is discharged from nozzles 42b formed on nozzle surfaces 42a, which are the surfaces of the head units 42 on the sheet S side, and arranged in the direction orthogonal to the conveyance direction of the sheet S toward the sheet S. For example, in the example illustrated in FIG. 3, two rows of nozzles 42b arranged in the direction orthogonal to the conveyance direction of the sheet S are formed on one nozzle surface 42a. Referring to FIG. 2, the two head units 42 are arranged side by side in the conveyance direction of the sheet S because the head units 42 are arranged in a staggered manner as illustrated in FIG. 3 to be described later.

The cap unit 43 is a unit that absorbs ink from the nozzles 42b and retains moisture on the nozzle surfaces 42a by abutting (capping) and closing caps 43a on the nozzle surfaces 42a of the head units 42. The cap unit 43 is movable in the sheet conveyance direction, for example. For example, in order to cap the nozzle surfaces 42a with the caps 43a, the cap unit 43 moves to a cap position 45 illustrated in FIG. 2. On the other hand, when the head units 42 discharge the ink to the sheet S, the cap unit 43 retracts to a retraction position 46 illustrated in FIG. 2.

As illustrated in FIG. 2, the liquid receiving unit 80 is arranged over the sheet S at a position ahead in the ink discharge direction of the head units 42 of the liquid discharge head 41, that is, a position facing the head unit 42 and on the lower side of the conveyed sheet S, that is, in the ink discharge direction of the liquid discharge head 41. A specific configuration of the liquid receiving unit 80 will be described later.

Next, a specific configuration of the liquid discharge heads 41 of the liquid discharge unit 40 will be described with reference to FIG. 3. As illustrated in FIG. 3, the liquid discharge heads 41 of the liquid discharge unit 40 are one-pass discharge heads. As illustrated in FIG. 3, in the liquid discharge unit 40, four liquid discharge heads 41 corresponding to K (black), C (cyan), M (magenta), and Y (yellow) are arranged from upstream to downstream in the conveyance direction of the sheet S. Hereinafter, the liquid discharge head 41 corresponding to K (black) will be referred to as liquid discharge head 41K, the liquid discharge head 41 corresponding to C (cyan) will be referred to as liquid discharge head 41C, the liquid discharge head 41 corresponding to M (magenta) will be referred to as liquid discharge head 41M, and the liquid discharge head 41 corresponding to Y (yellow) will be referred to as liquid discharge head 41Y. That is, the liquid receiving unit 80 is provided for each of the liquid discharge heads 41K, 41C, 41M, and 41Y.

All the four liquid discharge heads 41 corresponding to CMYK does not necessarily need to be provided. Liquid discharge heads 41 of different ink (for example, different colors such as green or light cyan, fluorescent coloring materials, and the like.) may be provided. The arrangement order of the four CMYK liquid discharge heads 41 is not limited to the order illustrated in FIG. 3.

The liquid discharge head 41K includes four head units 42 (42K-1 to 42K-4) arranged in a staggered manner. Thus, a K (black) image can be formed over the entire image forming area (printing area) of the sheet S. The number of head units 42 included in the liquid discharge head 41K is not limited to four, and may be different. Similarly, the liquid discharge head 41C includes four head units 42 (42C-1 to 42C-4) arranged in a staggered manner, the liquid discharge head 41M includes four head units 42 (42M-1 to 42M-4) arranged in a staggered manner, and the liquid discharge head 41Y includes four head units 42 (42Y-1 to 42Y-4) arranged in a staggered manner.

As places where the cap units 43 corresponding to the liquid discharge heads 41K, 41C, 41M, and 41Y retreat, retreating positions 46K, 46C, 46M, and 46Y are provided.

Configuration of Liquid Receiving Unit

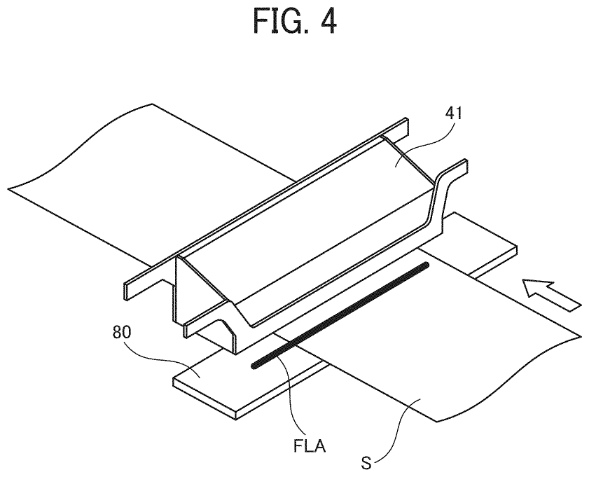

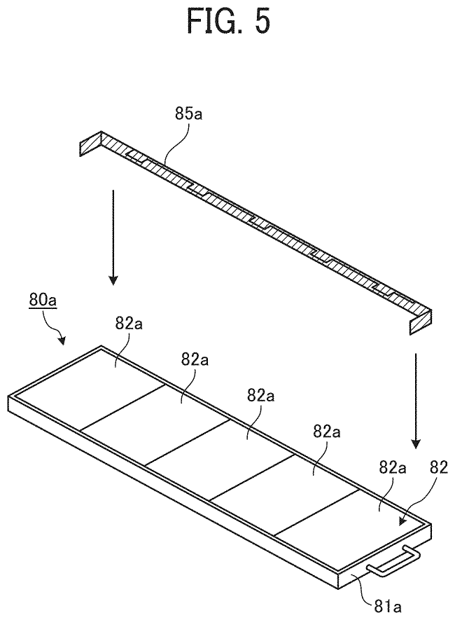

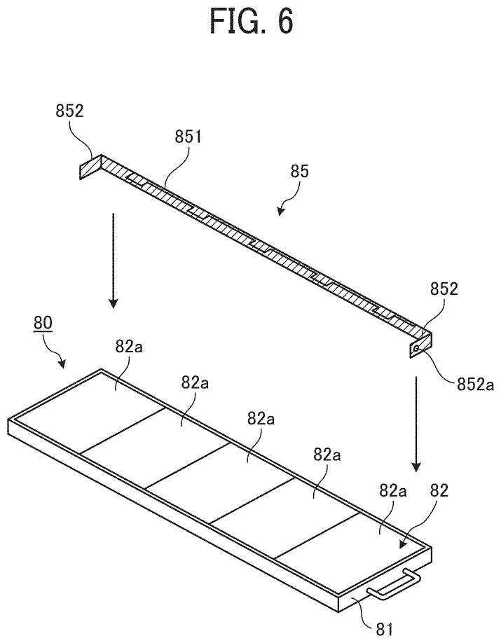

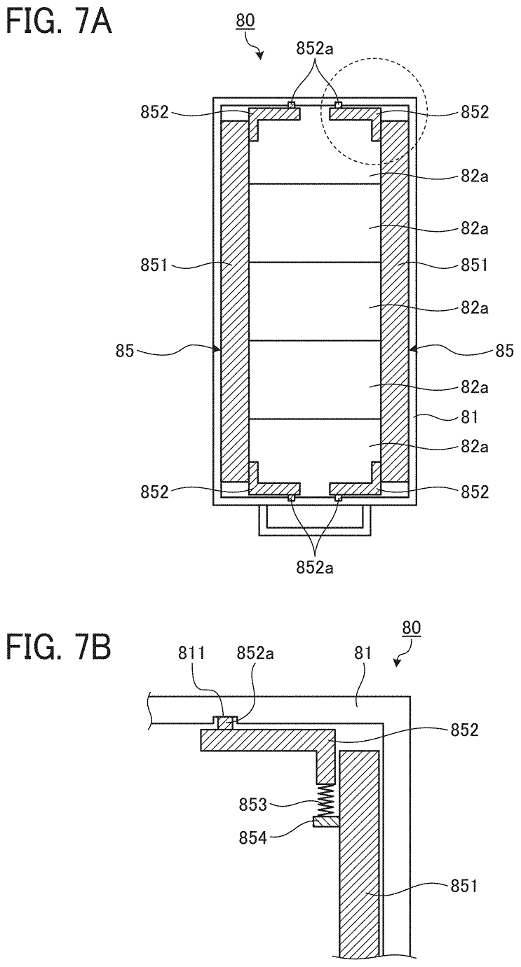

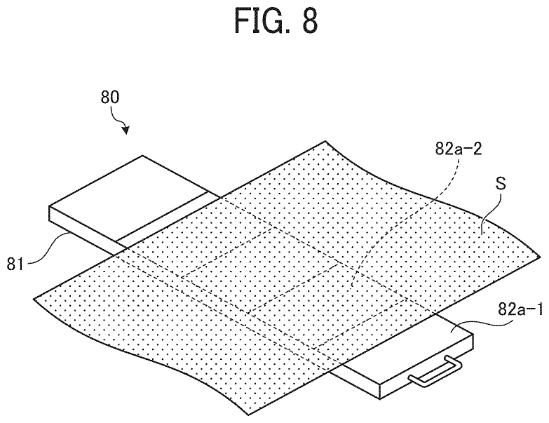

FIG. 4 is a diagram illustrating a positional relationship between the liquid discharge head and the liquid receiving unit in the liquid discharge apparatus according to the present embodiment. FIG. 5 is a diagram illustrating a configuration of a liquid receiving unit according to a comparative example. FIG. 6 is a diagram illustrating an example of a configuration of the liquid receiving unit according to the present embodiment. FIGS. 7A and 7B are plan views of the liquid receiving unit according to the present embodiment. FIG. 8 is a diagram illustrating an example of a positional relationship between the liquid receiving unit and the sheet according to the present embodiment. A configuration of the liquid receiving unit 80 in the liquid discharge apparatus 1 according to the present embodiment will be described with reference to FIGS. 4 to 8.

FIG. 4 illustrates a positional relationship between the liquid discharge head 41 and the liquid receiving unit 80. As described above, the liquid receiving unit 80 is arranged at a position in the ink discharge direction of the head unit 42 of the liquid discharge head 41, that is, at a position facing the head unit 42 and below the conveyed sheet S. In this case, when the liquid discharge head 41 performs flushing to the paper surface in an unnecessary area of the sheet S such as an area between pages of the sheet S, the ink is discharged from all the nozzles 42b of the head unit 42 arranged orthogonal to the conveyance direction of the sheet S indicated by arrow in FIG. 4, and as a result, the ink is discharged to a flushing area FLA illustrated in FIG. 4. Since there are various widths of the sheet S to be conveyed, the flushing area FLA may protrude from the paper surface as illustrated in FIG. 4. Thus, the liquid receiving unit 80 receives and absorbs the ink out of the flushing area FLA of the sheet S from which the ink has been discharged by flushing.

Here, a liquid receiving unit 80a according to a comparative example will be described with reference to FIG. 5. As illustrated in FIG. 5, the liquid receiving unit 80a includes a tray 81a, a melamine sponge 82, and a pressing member 85a.

The tray 81a is a box-shaped member for housing the melamine sponge 82.

The melamine sponge 82 is an absorber for landing and absorbing the ink discharged by flushing of the liquid discharge head. The melamine sponge 82 is divided into a plurality of divided sponges 82a. Further, on the lower side of the melamine sponge 82, a felt absorber having high ink retaintability is embedded, so that a two-layer structure is formed by the absorber and the melamine sponge 82. The sponge 82 is not limited to a melamine sponge, and may be a sponge other than a melamine sponge, a sheet-like absorber, or the like.

The pressing member 85a is a member for physically pressing the melamine sponge 82 from above. As illustrated in FIG. 5, the pressing member 85a extends in the longitudinal direction of the tray 81a. For convenience of description, FIG. 5 illustrates that the pressing member 85a is arranged on one of two longitudinal sides of the tray 81a. In practice, however, another pressing member is arranged on the other side, and a pair of pressing members is arranged on the sides.

As described above, in the configuration of the liquid receiving unit 80a illustrated in FIG. 5, the pressing member 85a is simply placed on the melamine sponge 82, and the position of the sponge is not fixed in the height direction. In addition, if the sheet S is likely to be electrically charged or its electrical charge amount is likely to increase, since the melamine sponge 82 of the liquid receiving unit 80a arranged under the sheet S is a member that is likely to be electrically charged, the electrical charge on the sheet S is likely to move toward the melamine sponge 82 by conveyance of the sheet S. When the melamine sponge 82 is electrically charged, the electric field on the lower side of the liquid discharge head becomes unstable, and the floating mist-like ink adheres to the nozzle of the liquid discharge head, so that discharge failure is likely to occur.

As described above, the position of the melamine sponge 82 is not fixed in the height direction, and the divided sponges 82a are likely to float due to electrical charging of the melamine sponge 82, and the divided sponges 82a or the pressing member 85a may come into contact with the sheet S. In addition, since the pressing member 85a is not fixed to the tray 81a, the pressing member 85a is in an electrically floating state, and thus electrical charge is likely to accumulate in the pressing member 85a, which contributes to destabilization of the electric field on the lower side of the liquid discharge head.

Therefore, the liquid receiving unit 80 in the liquid discharge apparatus 1 according to the present embodiment has a configuration as illustrated in FIGS. 6, 7A, and 7B.

As illustrated in FIG. 6, the liquid receiving unit 80 includes a tray 81, a melamine sponge 82, and a pressing member 85.

The tray 81 is a box-shaped member for housing the melamine sponge 82 so as to be exposed to a nozzle surface 42a of the liquid discharge head 41.

The melamine sponge 82 is an absorber for landing and absorbing the ink discharged by flushing of the liquid discharge head. The melamine sponge 82 is impregnated with, for example, a moisturizing liquid. The melamine sponge 82 is formed of a porous body, and is divided into a plurality of divided sponges 82a in a direction orthogonal to the conveyance direction of the sheet S, that is, in an alignment direction of the nozzles 42b formed in the head unit 42 of the liquid discharge head 41. Further, on the lower side of the melamine sponge 82, a felt absorber having high ink retaintability is embedded, so that a two-layer structure is formed by the absorber and the melamine sponge 82. As described above, when being divided into the plurality of divided sponges 82a in the direction orthogonal to the conveyance direction of the sheet S, as illustrated in FIG. 8, the plurality of divided sponges 82a includes a divided sponge 82a-1 that receives the ink by flushing and a divided sponge 82a-2 that does not receive the ink by flushing according to the width of the sheet S. Depending on the type of ink discharged by flushing, the ink discharged to the melamine sponge 82 may be dried or deposited. If the deposits grow in the height direction and come into contact with the sheet S, the sheet S may become contaminated. In order to prevent contamination of the sheet S due to the growth of deposits, it is necessary to periodically replace the melamine sponge 82. However, since the sponge 82 is divided into the plurality of divided sponges 82a in the direction orthogonal to the conveyance direction of the sheet S, only the divided sponge 82a-1 having received the ink by flushing needs to be replaced among the divided sponges 82a, so that the consumption amount of the melamine sponge can be suppressed.

The melamine sponge 82 is divided in the direction orthogonal to the conveyance direction of the sheet S. However, as described above, since the plurality of head units 42 is arranged in a staggered manner in the liquid discharge head 41, the melamine sponge may be further divided in the conveyance direction. This makes it possible to subdivide the divided sponges that are to be replaced at the time of receipt of the ink by flushing, so that the consumption amount of the melamine sponge 82 can be further suppressed. The pressing member 85 is a member that physically presses the melamine sponge 82 from above toward the bottom surface of the tray 81. As illustrated in FIG. 6, the pressing member 85 extends in the longitudinal direction of the tray 81. For convenience of description, FIG. 6 illustrates that the pressing member 85 is arranged along one of two longitudinal sides of the tray 81. In practice, however, as illustrated in FIG. 7A, another pressing member is arranged on the other side, and a pair of pressing members is arranged on the sides.

As illustrated in FIGS. 6 and 7A, each of the pressing members 85 includes a base material 851 extending in the longitudinal direction of the tray 81, that is, in the alignment direction of the nozzles 42b of the liquid discharge head 41, and two end members 852 connected to end sides of the base material 851 as seen in the longitudinal direction.

As illustrated in FIG. 7A, the base material 851 is a member that prevents floating of the plurality of divided sponges 82a by pressing the divided sponges 82a from above.

The end members 852 are, for example, L-shaped conductive members as illustrated in FIG. 7B. First ends of the L-shaped end members 852 are connected to retaining members 854 erected on end portions of the base material 851, with spring members 853 in between, which are elastic bodies that can expand and contract in the longitudinal direction of the tray 81 (the direction of arrow illustrated in FIG. 7B). This allows the end members 852 to be displaced in such a manner as to be biased to the inner wall surface in the longitudinal direction of the tray 81 with respect to the base material 851 by the elasticity of the spring members 853. As illustrated in FIG. 7B, each of the L-shaped end members 852 has a projection 852a (an example of a first fitting portion) erected on a surface facing the inner wall surface of the short side of the tray 81, and the tray 81 has a recess 811 (an example of a second fitting portion) formed in the inner wall surface of the short side. Then, when the pressing member 85 is placed in the tray 81, the projection 852a is fitted into the recess 811 in the inner wall surface. Accordingly, the pressing member 85 is positioned in the height direction and the heightwise position is fixed, it is possible to suppress the contact of the divided sponges 82a or the pressing member 85 with the sheet S due to the floating of the divided sponges 82a. Since the end members 852 are biased against the inner wall surface of tray 81 by the elastic force of the spring members 853, the end members 852 reliably come into contact with the inner wall surface, so that the floating state of the pressing member 85 can be alleviated. Accordingly, the pressing member 85 becomes at the same potential as the tray 81, and the tray 81 is grounded so that the pressing member 85 is also grounded, and the divided sponges 82a and the pressing member 85 are prevented from being electrically charged. Since the end members 852 are conductive members, the electric charge in the pressing member 85 can be more easily released through the end members 852 and the tray 81. Therefore, it is possible to suppress the occurrence of an event in which the mist-like ink floating adheres to the nozzles of the liquid discharge unit 40 and causes a discharge failure due to the unstable electric field on the lower side of the liquid discharge unit 40.

The liquid receiving unit 80 is configured such that the projections 852a of the end members 852 of the pressing member 85 and the recesses 811 in the inner wall surface of the tray 81 are fitted to each other, but is not limited to this configuration. That is, recesses (an example of a first fitting portion) may be formed in the end members 852, and projections (an example of a second fitting portion) may be formed in the inner wall surface of tray 81, and these may be fitted to each other.

In the example illustrated in FIG. 7A and 7B, the end members 852 are biased to the inner wall surface of the tray 81 by the elastic force of the spring members 853, but the present invention is not limited to this configuration. The end members 852 themselves may be elastic bodies and directly connected to the retaining members 854. Even with such a configuration, the end members 852 reliably contact the inner wall surface of the tray 81, so that the floating state of the pressing member 85 can be alleviated.

Numerous additional modifications and variations are possible in light of the above teachings. It is therefore to be understood that, within the scope of the above teachings, the present disclosure may be practiced otherwise than as specifically described herein. With some embodiments having thus been described, it will be obvious that the same may be varied in many ways. Such variations are not to be regarded as a departure from the scope of the present disclosure and appended claims, and all such modifications are intended to be included within the scope of the present disclosure and appended claims.

1. A waste liquid collection unit to be located over a print medium in a discharge direction in which a liquid discharge head discharges liquid, the waste liquid collection unit comprising:
an absorber to absorb the liquid discharged from the liquid discharge head;
a tray housing the absorber such that the absorber is exposed to a nozzle surface of the liquid discharge head; and
a pressing member pressing the absorber toward a bottom surface of the tray,
the pressing member including:
a base material extending in an alignment direction of nozzles of the liquid discharge head; and
end members connected to ends of the base material and displaceable in such a manner that the end members are biased to an inner wall surface of the tray in an axial direction of the base material when the pressing member is placed in the tray,
the end members including a first fitting portion in a surface facing the inner wall surface, and
the tray including a second fitting portion in the inner wall surface, and
the first fitting portion and the second fitting portion being fitted to each other when the pressing member is placed in the tray.

2. The waste liquid collection unit according to claim 1,
wherein the end members have electric conductivity.

3. The waste liquid collection unit according to claim 1, further comprising elastic bodies connecting the end members to the ends of the base material.

4. The waste liquid collection unit according to claim 1,
wherein the end members include elastic bodies and connected to end portions of the base material.

5. The waste liquid collection unit according to claim 1,
wherein the absorber is divided into a plurality of parts in the alignment direction of the nozzles of the liquid discharge head.

6. The waste liquid collection unit according to claim 5,
wherein the absorber is further divided into a plurality of parts in a conveyance direction of the print medium.

7. A liquid discharge apparatus comprising:
the liquid discharge head; and
the waste liquid collection unit according to claim 1.

8. The liquid discharge apparatus according to claim 7, further comprising a plurality of liquid discharge heads, including the liquid discharge head, provided in one-to-one correspondence with a plurality of types of the liquid, and
a plurality of waste liquid collection units, including the waste liquid collection unit, arranged in one-to-one correspondence with the plurality of liquid discharge heads.
